(19) United States
(12) Patent Application Publication
(10) Pub. No.: US 2026/0058448 A1
(43) Pub. Date: Feb. 26, 2026

(54) TROUGH FIXING SUPPORT STRUCTURE, TROUGH LINE INCLUDING THE SAME, TROUGH STRUCTURE AND METHOD FOR SUPPORTING AND FIXING THE SAME, AND TROUGH FIXING SUPPORT MEMBER FOR USE THEREIN

(71) Applicant: FURUKAWA ELECTRIC CO., LTD., Tokyo (JP)

(72) Inventors: Takashi Hori, Tokyo (JP); Satoshi Kozawa, Tokyo (JP); David John Maher, Port Kembla (AU); Jim Xidis, Port Kembla (AU)

(21) Appl. No.: 19/376,263

(22) Filed: Oct. 31, 2025

Related U.S. Application Data
(63) Continuation of application No. PCT/JP2025/006170, filed on Feb. 21, 2024.

(30) Foreign Application Priority Data
Feb. 21, 2024 (JP) 2024-024376

(51) Int. Cl. H02G 3/04; F16L 3/12

(52) U.S. Cl. CPC H02G 3/0456; F16L 3/1226

(57) ABSTRACT

A support column structure includes a vertical support column, a horizontal support column, and/or an oblique support column, which are made of hollow fiber-reinforced resin members having substantially rectangular cross sections. The support column structure further includes a plurality of S-shaped trough fixing support members. Each of the S-shaped trough fixing support members includes an inverted U-shaped first fixing portion and a normal U-shaped second fixing portion, which are joined with each other. By hooking and fixing the inverted U-shaped first fixing portions onto the horizontal support column or the oblique support column, a trough can be placed on the normal U-shaped second fixing portions, thereby obtaining a trough fixing support structure. The present invention can also provide a direction changing structure that includes the trough fixing support structure and various types of angle members.

### TECHNICAL FIELD

The present invention relates to a trough fixing support structure, a trough line including the same, a trough structure and a method for supporting and fixing the same, and a trough fixing support member for use therein.

### BACKGROUND OF THE INVENTION

As protective tubes for electric wires and cables, troughs and electrical conduits are conventionally known. Electrical conduits include, in addition to those having circular cross sections, rectangular electrical conduits having substantially square tube cross sections, which are used for multitier-multirow arrangements. However, such the rectangular electrical conduits have smaller wall thickness than troughs and thus lack strength and rigidity to be laid above the ground. Thus, although it is possible to bury the entire electrical conduits mainly underground to be disposed in multiple tiers and multiple rows, the electrical conduits are not to be laid in multiple tiers and multiple rows above the ground.

Also, as a method for laying the electric conduits having the circular cross sections in multiple tiers and multiple rows, there is a method in which rectangular blocks each having a rectangular outer periphery and a semi-circular inner surface are used being turned upside down so as to sandwich the electrical conduit with a circular cross section, and stacked in multiple tiers to build a multitier-multirow circular cross-sectional electrical conduits burying structure.

On the other hand, as locations for wind power generation, the use of not only flat grounds but also mountainous areas and sloping grounds have been advancing recently. In a case of the sloping grounds, in addition to difficulty in construction work of underground burying, it is also necessary to take into account risks of landslides or the like and ease of maintenance of electrical cables, and thus a development for trough laying rack system that can cope with the sloping grounds has been awaited. Thus, a connection structure between a rack, in which a support surface of a support member can be set at a predetermined angle to correspond the slope, and a support pile, a trough line including the same, and fixed connection fittings and angle-variable connection fittings that are used therein have been developed.

Moreover, trough bridges are used as a way of constructing and laying troughs on the ground. Trough bridges include a width-variable trough bridge, with excellent workability, on which a receiving platform can be installed with both side portions thereof not protruding from the trough bridge.

There is also a trough structure in which troughs are connected and disposed on a trough bridge. In the trough structure, tip ends of both leg portions of H-shaped support piles are buried underground alongside rail tracks or the like and the support piles having trough support portions are laid at predetermined intervals on the opposite side such that troughs can be connected and disposed over the support piles.

Also, when disposing troughs on the ground, there is a case in which bottom parts and side plates of the troughs are buried in gravel up to a predetermined height to be stabilized, or there is a structure in which the troughs are buried in the ground up to top parts of the side plates forming a substantially U-shaped opening with lid portions being protruded to the ground surface.

In addition to the above, there is a metal-made trough or the like that includes a metal-made trough body that is continuously hollow in an axial direction and has an opening that is continuous in the axial direction, a metal lid body that is continuous along the axial direction of the trough body and is attached to the opening, and a fixing fitting that fixes the lid body to the trough body. For example, in the metal-made trough, a fixing flange is provided being protruded on each of the trough body and the lid body and the fixing flanges are joined together by the fixing fitting. Thus, if there is leakage of electricity in the metal-made trough, there are risks of electrification.

As above, there are ways to stack and lay the rectangular conduits in the multitier-multirow arrangement or to bury the circular cross-sectional conduits underground in the multitier-multirow arrangement by using the rectangular blocks, as well as a construction method that uses the trough bridge to construct the troughs in a row. However, there has been no construction method that enables the multitier-multirow laying above the ground, which also prevents electrification. Also, there are methods using wire common ducts or cable tunnels when burying the troughs underground. The laying above the ground has an advantage that there is no need to dig up the ground when there are more troughs to be laid or at the time of maintenance, and, the present invention has achieved a trough fixing support structure including a structure that can easily attach and support troughs in a multitier-multirow arrangement in the case of laying above the ground.

Looking at patent documents, an object of an invention according to Japanese Patent Application Laid-Open Publication No. 2000-320743 (JP-A-2000-320743) is to provide a pipe body with great advantages of being able to stably and easily stack any number of pipe bodies in multiple rows and tiers, thereby making it possible to easily form a multi-hole pipeline underground, in which, furthermore, a structure of the pipe body hardly causes land subsidence even if rain or vibration is applied to the soil covering a trench forming the pipeline and thus special countermeasures to prevent such the land subsidence phenomenon is unnecessary. To achieve the above object, JP-A-2000-320743 has proposed a pipe body P including a convex portion 2 having a large rectangular cross section and a concave portion 3 having a small circular cross section, wherein the convex portions 2 and the concave portions 3 are disposed along a pipe axis direction alternately to have a convex-concave shape on a pipe wall 1, and a rib-shaped protruded wall 4, 4 that stretches from an outer periphery of the concave portion 3 to a substantial outer periphery of two facing sides of the convex portion 2 is formed along the pipe axial direction. In addition to the above, structures of the similar aspect are disclosed in Japanese Patent No. 6391903 and Japanese Patent Application Laid-Open Publication No. 2006-322491.

An object of an invention according to Japanese Patent Application Laid-Open Publication No. 2022-53346 (JP-A-2022-53346) is to provide a joint structure of racks and support piles in which a support surface of a support member can be set at a predetermined angle according to a slope. The joint structure includes at least one of a straight joint portion and a sloped joint portion joining the racks, a trough line including the same, and fixed joint fitting and angle-variable joint fitting that are used therein. To achieve the above object, the following arts are disclosed. That is, a support pile mainly includes an H-shaped frame portion 7 including two substantially parallel support columns 3 and a connecting portion 5 connecting the support columns 3 to one another, and a rotatable support portion 9 having an L-shaped cross section. An elbow portion 19 of the rotatable support portion 9 is fixed rotatably to the support column 3 with a bolt. A rack 21 is fixed to the rotatable support portion 9 of the support pile 1. In a trough line 90, at least one of a straight joint portion 55 in which the racks 21 are joined in a straight line with fixed joint fittings 43 and a sloped joint portion 95 in which the racks 21 are joined at a different angle with angle-variable joint fittings 59 (59a) is formed.

An object of an invention according to Japanese Patent Application Laid-Open Publication No. 2018-33195 (JP-A-2018-33195) is to provide a trough support member that is easy to work with and can prevent the trough support member from sinking or falling over, a method for laying the trough support member, and a trough bridge. To achieve the above object, the followings are disclosed. A trough support member 1 mainly includes a support column 3, a fixing member 5, and so on. The support column 3 is a member having an L-shaped cross section, for example. At least two support columns 3 of a predetermined length are fixed and joined by the fixing member 5 in the vicinity of heads 13 of the support columns 3, which are substantially parallel to each other and spaced apart by a predetermined distance. The fixing member 5 includes a trough receiver installation member 7 provided at an upper part and a subsidence prevention member 9 provided at a lower part. A trough receiver installation surface 15 is a part on which the trough receiver is installed. Also, a subsidence prevention surface 17 is a part that comes into contact with the ground when the trough support member 1 is hammered into the ground, and is for preventing the support columns 3 from sinking further deeper.

An object of an invention according to Japanese Patent Application Laid-Open Publication No. 2008-236830 (JP-A-2008-236830) is to provide a width-variable trough bridge with excellent workability, on which a receiving platform can be installed with both side portions thereof not protruding from the trough bridge. To achieve the above object, the trough bridge includes a plurality of flat plate-shaped receiving platforms attached to a support column erected on the ground, and support frames, with angle-shaped cross sections, that are attached to the receiving platforms facing each other to support a trough. The trough bridge is most characterized in that each of the support frame is held, while being restricted in movement in a width direction of the support frame, by a pair of sandwiching plates sandwiching a horizontal portion of the support frame, overlapping each other and extending beyond the horizontal portion toward the center of the receiving platform, the pair of the sandwiching plates are fixed to the receiving platform by a bolt inserted into bolt holes of the sandwiching plates and the receiving platform and a nut, and one of the bolt holes is a hole that is elongated along the width direction. The one of the bolt holes may be a plurality of holes with slightly larger diameters formed at a predetermined pitch along the width direction.

An object of an invention according to Japanese Patent Application Laid-Open Publication No. 2015-142387 (JP-A-2015-142387) is to provide a method of constructing a cable trough bridge that requires no manual excavation of abutment foundation or anchor blocks with no difficulty in disposal of the excavated soil, wherein the cable trough bridge is light weight and can be carried easily to slopes or the top of slopes where cable troughs are to be laid, thereby making the cost for laying cable troughs extremely cheap, and a cable trough bridge laying member. To achieve the above object, it has been proposed that a pair of support piles are hammered into a cable trough bridge construction site with an interval therebetween determined, and a retaining rod having a pair of ring-shaped support pile fitting rings at both ends is inserted into the support piles from an upper end side of the hammered support piles and attached between the support piles, a cable trough fixing tool that can be adjusted to expand and contract in a width direction of the cable trough bridge is attached onto the retaining rod, and the cable trough is laid between the attached cable trough fixing tools.

An object of an invention according to Japanese Patent Application Laid-Open Publication No. 2002-199533 (JP-A-2002-199533) is to provide a metal-made trough that allows easy cable laying installation work and maintenance, such as replacement of cables after laying installation, and prevents danger, such as jumping up of an upper lid due to vehicle vibration. To achieve the above object, the following has been proposed. That is, the metal-made trough includes a metal-made trough body 2 that is hollow in an axial direction and has an opening 4, which is continuous in the axial direction, at a corner portion, a metal-made lid body 3 that is continuous along the axial direction of the trough body 2 and is attached to the opening 4, and a fixing fitting 7 that fixes the lid body 3 to the trough body 2. A fixing flange 2e having a pin hole 2f is provided being protruded on the trough body 2 and a fixing flange 3c having a pin hole 3d is provided being protruded on the lid body 3. A U-shaped clip is inserted into the pin holes 2f and 3d as the fixing fittings 7.

An invention according to National Publication of International Patent Application No. 2022-549975 (JP-A-2022-549975) relates to a cable trough made of frame-retardant fiber-reinforced plastic (FR-FRP), which is configured to store high-voltage transmitting cables inside a cable tunnel. The specific measures include the following: a cable trough system includes a plurality of rectangular members that are connected in series and are joined to each other to form an elongated body, each of the rectangular members including an upper casing and a lower trough, a plurality of pairs of an upper bracket and a lower bracket that are fixed to a joint portion between edges of the upper and lower casings of the two adjacent rectangular members, and a plurality of belts each of which can be slidably engaged with a corresponding buckle. Each of the belts includes an explosive force absorbing/elastic/resistant polymer fiber band. Each buckle includes an outer frame that supports one or more cross bars that capture the band to wrap/fix the belt around the rectangular member. Each buckle is configured to slide the corresponding belt a limited distance to allow the upper casing of the rectangular member to be lifted upwardly and away from the lower casing to create a gap for venting increased air pressure in the event of a fire/explosion accident. The invention according to Patent Document 7 is an invention in which troughs are buried underground and further assumes explosions in the event of a fire or explosion accident, but is not an invention in which the troughs are laid above the ground.

An object of an invention according to Japanese Patent Application Laid-Open Publication No. 11-220827 (JP-A-11-220827) is to obtain a cable support fitting that can completely fix a support arm with attachment brackets, and can withstand long-term use. As measures to achieve such the object, the cable support fitting that supports a cable 7 at a fixed angle A in a vertical direction of an inner wall of a tunnel has been proposed. The cable support fitting includes a pair of attachment brackets 1A and 1B that are fixed with a bolt and a nut while sandwiching a fixed wall a of the fixed angle A, and a horizontal support arm 2 with a box-shaped cross section, which is welded to the attachment brackets 1A and 1B in a cantilever manner with a middle portion of the attachment brackets 1A and 1B received in an engagement groove 3 cut from a base end surface thereof, and supports a cable 7 on an upper surface thereof. Openings 5A and 5B into which a welding rod can be inserted are formed at the base of the side wall of the support arm 2 corresponding to the attachment brackets 1A and 1B, and the attachment brackets 1A and 1B and the support arm 2 are welded through the openings 5A and 5B.

As other structures, conventionally, hot-dip galvanized metal-made troughs have been used in some cases. In such the case, support columns are also made of iron, and, as countermeasures for electrical leakage accidents, it is necessary to provide insulating materials between the troughs, as well as earthing is also required. Also, in the case of metal-made troughs, the trough length is as long as 6 meters, and thus construction efficiency is poor when adapting to site environment with many bent parts or the like. Also, in the case of metal-made troughs, there are no joint structures, and thus foreign substances or small animals may enter into the joint portion. Also, there is no freedom in installation positions of hooks that support and fix the troughs to the supporting columns for supporting such the troughs, and thus the hooks are fixed in use. Although a two-tiered concrete trough structure using H-shaped steel has been proposed, such the structure cannot have more tiers and a support base is made of metal, which poses problems such as the risk of electrification.

### SUMMARY OF THE INVENTION

In view of the above prior arts, it is an object of the present invention to provide a trough fixing support structure that can be laid above the ground, in which a plurality of troughs can be laid without spreading in a width direction of a path as much as possible and a risk of electrification can be suppressed even without earthing, with excellent workability. Also, the present invention is to provide the trough fixing support structure in which hooks for supporting the troughs (trough fixing support members) can be easily attached with enhanced degree of installation freedom, while enabling stable installation of a trough structure. Furthermore, this provides a new construction method for troughs as protective members for electric wires and cables, replacing rack systems that have been applied to various underground electric conduits and slopes.

A trough fixing support structure according to the present invention is a structure having a support column structure in which horizontal support columns and vertical support columns orthogonally intersecting with each other are assembled in parallel-cross arrangement. The present invention provides the trough fixing support structure that can lay a trough structure, which can easily change supporting position of troughs in the support column structure by adjusting positions of trough fixing support members, and a method for supporting and fixing the trough fixing support members used therein and the trough structure in which the troughs are laid. In the trough fixing support structure according to the present invention, oblique support columns that intersect obliquely to the vertical support columns may be used in place of the horizontal support columns, or the horizontal support columns as well as the oblique support columns may be used at the same time.

In the present invention, by connecting either the horizontal support column or the oblique support column of the first support structure of two trough fixing support structures facing different directions to either the horizontal support column or the oblique support column of the other trough fixing support structure at a predetermined angle to each other, it is possible to obtain the trough fixing support structure having troughs facing at least different directions from one another. By connecting support structures of mutually different angles, it is possible to obtain a direction changing structure for the trough support structure without using a direction changing member. Here, when connecting together the support structures facing different directions to obtain the direction changing structure without using a direction changing member, it is necessary to cut ends of the two troughs to be connected being tilted at a predetermined angle in a predetermined direction.

Here, in the present invention, the term “direction changing structure” is defined as meaning any structure in general that does not have a simple linear shape, such as a direction changing structure in which troughs fixed to a trough support structure or an angle member is guided in a direction different from a predetermined direction, or a structure in which troughs fixed to a support structure or an angle member branches in another different direction in addition to the predetermined direction.

For example, structures of which directions are changed from the support structure by various direction changing members can be provided. Here, possible direction changing members for guiding the support structure in different directions include an upward-downward gradient angle member, a T-shaped branching angle member, a bending member, an S-shaped bending angle member, and an inverted S-shaped bending angle member, which are to be connected to a trough fixing member to form the direction changing structure. By combining such direction changing structures, it is possible to provide a variety of trough systems including a trough support structure in which troughs are laid. Also, the present invention also provides an S-shaped trough fixing support member that is used in the trough support structure and includes an inverted U-shaped first fixing portion and a normal U-shaped second fixing portion, and in such the trough fixing support member, a shape of the support structure differs depending whether a cross-sectional structure of the support column forming the trough support structure is hollow or solid. If the cross section of the support column is solid, a width of the inverted U-shaped first fixing portion of the trough fixing support member is smaller than in a case in which the cross section of support column is hollow.

In a trough fixing support structure according to a first aspect of the present invention, an invention according to claim 1 is a support structure assembled by using hollow fiber-reinforced resin members having substantially rectangular cross sections as horizontal and/or oblique support columns and vertical support columns, and by fixing the horizontal support columns in one or more tiers with fixing bolts to one or both sides of the vertical support columns, which are buried in the ground or supported and fixed by concrete at predetermined intervals, with at least the horizontal support columns being substantially perpendicular to the vertical support columns, or the oblique support columns being oblique to the vertical support columns. The support structure further includes a plurality of S-shaped trough fixing support members.

Each of the plurality of S-shaped trough fixing support members is configured such that an inverted U-shaped first fixing portion and a normal U-shaped second fixing portion are integrally connected to each other, and the plurality of trough fixing support members are fixed by hooking the inverted U-shaped first fixing portion onto any position of the horizontal support columns or the oblique support columns where the horizontal support columns or the oblique support columns do not interfere with the vertical support columns, and a plurality of troughs can be placed on the normal U-shaped second fixing portions of the plurality of trough fixing support members.

By employing such the structure, the troughs can be installed in multiple tiers in a direction vertical to the ground by combining the support columns of fiber-reinforced resin members. Thus, multiple troughs can be laid without spreading in a width direction of the path as much as possible. Furthermore, because of the fiber-reinforced resin member, risk of electrification can be suppressed even without earthing and all the components are light weight, thereby providing the trough fixing support structure with excellent workability. In the trough fixing support structure of the present invention, degree of freedom in installation of the trough fixing support members is enhanced and easy and stable trough fixing is possible. Here, although the horizontal support columns and the vertical support columns of the structure of the present invention are normally laid so as to intersect substantially perpendicularly to each other, the oblique support columns may also be used on slope surfaces so as to intersect obliquely.

As above, when using the support columns formed of the hollow fiber-reinforced resin members, strength of the support columns are reinforced by fiber, which eliminates concerns about corrosion or the like, and thus it is possible to maintain the strength, durability, and impact resistance of the support columns and it is possible to obtain the trough fixing support structure that can sufficiently maintain required properties even if the trough fixing support structure is used for a long period of time.

Furthermore, in the trough fixing support structure of the present invention, an invention according to claim 2 is the support structure in which at least either of the horizontal support columns or the oblique support columns are assembled in one or more tiers with fixing bolts. The troughs that are arranged continuously form a trough structure, each of the troughs including a trough body having a substantially U-shaped cross section and a trough lid placed on and fixed to the trough body. The continuous arrangement of the trough structure is configured by either a male-female joint structure of the adjacent troughs or a close-arrangement of the troughs having only trough storages, without the male-female structure, and the matching trough lids. The trough structure is disposed either on the horizontal support columns or the oblique support columns that are disposed on the one or both sides of the vertical support columns, and the troughs of the trough structure are placed on the second fixing portions of the S-shaped trough fixing support members. By employing such the structure, the trough fixing support structure of the present invention is a support structure in which the troughs can be placed and fixed stably with high degree of freedom via the trough fixing support members.

Furthermore, in the trough fixing support structure of the present invention, an invention according to claim 3 is the trough fixing support structure in which, when the inverted U-shaped first fixing portion is mounted on the horizontal support column or the oblique support column, two holes are provided in the first fixing portion of the S-shaped trough fixing support member at mutually opposing and symmetrical positions at parts extending below a position corresponding to a lower surface of a support column cross section of either the horizontal support column or the oblique support column so as not to obstruct an insertion of a bolt, and the bolt is inserted into the two holes and tightened with a nut to fix the trough fixing support member to the horizontal support column or the oblique support column.

By employing such the structure, the trough fixing support structure of the present invention enables to dispose the trough fixing support members freely at any positions without being restricted by screw holes or the like of the horizontal support columns thereof, and the troughs can be placed and fixed firmly and stably by tightening the support columns with the bolt and nut.

Also, in the trough fixing support structure of the present invention, an invention according to claim 4 is the trough fixing support structure in which a bottom portion of each of the troughs of the trough structure placed on the second fixing portion is simply placed on the second fixing portion, or bolt insertion holes are provided at predetermined positions of the second fixing portion and the bottom portion of each of the troughs of the trough structure placed on the second fixing portion and a bolt is inserted into the bolt insertion holes and fixed to the second fixing portion with a nut. As above, the troughs can be simply placed on the second fixing portion of the trough fixing support member, or may be fixed with bolts. However, when considering safety of the troughs in the event of an earthquake or the like, bolt fixing is preferable.

Furthermore, in the trough fixing support structure of the present invention, an invention according to claim 5 is the trough fixing support structure in which, when the trough structure is to be fixed to the horizontal support column or the oblique support column configuring the trough fixing support structure, one or two of the trough fixing support members are to be provided for each of the troughs of the trough structure. By employing such the structure, the troughs can be placed and fixed efficiently with a small number of the trough fixing support members, making it highly economical.

Furthermore, in the trough fixing support structure of the present invention, an invention according to claim 6 is the trough fixing support structure in which, when the one trough fixing support member is disposed for each trough in a longitudinal direction of the troughs of the trough structure fixed to the horizontal support column configuring the trough fixing support structure, the trough fixing support member supports a position that is a predetermined distance away from a center of gravity of the trough toward the female joint structure. By employing such the structure, the troughs can be placed and fixed to the horizontal support columns with a small number of the trough fixing support members, making it highly economical.

In the trough fixing support structure of the present invention, an invention according to claim 7 is the trough fixing support structure in which a flat-plate shaped or substantially C shaped long support base is disposed between the trough bottom portion of the trough structure placed on the second fixing portion of the trough fixing support member and the second fixing portion. In this way, the troughs can be installed and fixed more stably. If the support base has a length of the two or three troughs, the trough fixing support members may be arranged at both ends thereof, which contributes to saving on the trough fixing support members.

The troughs used in the trough fixing support structure of the present invention are mainly made of resin. However, metal-made troughs may also be used. In the trough fixing support structure of the present invention, an invention according to claim 8 is the trough fixing support structure in which the troughs placed on the trough fixing support members are metal-made troughs having the same cross-sectional shape in the longitudinal direction, and the metal-made troughs are fixed to the trough fixing support members in a state in which the metal-made troughs are abutted against each other and continuously arranged, or the metal-made troughs are fixed to the trough fixing support members in a state in which a gap is created between the metal-made troughs and the gap is covered with a cover member.

The metal-made trough is manufactured by roll forming a metal plate and thus is longer than the resin-made trough or the like. For this reason, a small number of the metal-made troughs can reliably store and protect electric wires over long distances by suitably corresponding to an extending direction of the electric wires.

When using the metal-made troughs, in any of the above cases, to prevent electrification due to electrical leakage accidents, it is necessary to install grounding wires at predetermined intervals for earthing. Thus, the metal-made troughs are used at least partly and auxiliary in the present invention.

Also, in the trough fixing support structure of the present invention, an invention according to claim 9 is the trough fixing support structure in which, instead of the hollow fiber-reinforced resin members having the substantially rectangular cross sections, the solid fiber-reinforced resin members having substantially rectangular cross sections are used for the horizontal and oblique support columns, and at least one of long sides of the horizontal and oblique support columns having substantially rectangular cross sections is abutted to the vertical support column to be fixed. In such the case, the solid fiber-reinforced resin members having substantially rectangular cross sections are never to be used as the vertical support columns. This is because, for example, assuming that the hollow support column and the solid support column have substantially the same cross sections, a surface area of the support column is smaller when using a solid support column, and thus a contacting area between the support column and soil is reduced, thereby deteriorating stability when the support column is buried in the soil. At this time, the substantially rectangular solid fiber-reinforced resin member used here has a long side having substantially the same height as a support column that is normally used as the hollow-shaped horizontal or oblique support column. However, a short side thereof corresponding to a width of the solid member is smaller than a width of the support column.

Thus, while a shape of the inverted U-shaped first fixing portion of the S-shaped trough fixing support member is to be changed to match the width of the solid support column, a shape of the second fixing portion on which the troughs are placed remains the same as in the conventional case.

As above, even if the support column made of the solid fiber-reinforced resin member is used, it is possible to maintain the strength, durability, and impact resistance similarly as in the case of using the hollow support column, and thus it is possible to sufficiently maintain the required strength of the trough fixing support structure even after long-term use.

In the trough fixing support structure of the present invention, an invention according to claim 10 is the trough fixing support structure in which the hollow or solid fiber-reinforced resin member having the substantially rectangular cross section is a fiber-reinforced resin composite material that is formed of at least one of thermoplastic resin and thermosetting resin with glass fiber formed of filamentous filament, and the glass fiber is disposed on a surface of the fiber-reinforced resin member with the filamentous filament as a continuous body.

In the trough fixing support structure of the present invention, an invention according to claim 11 is the trough fixing support structure in which the fiber-reinforced resin member of the trough fixing support structure is made of either thermoplastic resin or thermosetting resin. The thermoplastic resin is any one of polypropylene resin, ABS resin, PC resin, PBT resin, PPO resin, and PA resin, or the thermosetting resin is either urethane resin or epoxy resin. The glass fiber is disposed such that filament is wound around the surface of the fiber-reinforced resin member in parallel or at a predetermined angle to the longitudinal direction, or is intertwined and wound around the surface at a predetermined angle.

In the trough fixing support structure of the present invention, an invention according to claim 12 is the trough fixing support structure in which the support structure includes the horizontal or oblique support columns that are assembled in multiple tiers with fixing bolts. The horizontal or oblique support columns of another support structure are fixed to the other support structure being tilted at a predetermined angle in the horizontal or vertical direction relative to the horizontal or oblique support columns of the support structure so as to be connected to at least one end of the horizontal or oblique support columns of the multiple tiers in a different direction, such as obliquely downward or obliquely to the side, such that the trough fixing support structure includes a direction changing structure for directing a part of the troughs of the trough structure fixed to the horizontal or oblique support columns of the support structure in a direction different from an original arrangement direction of the troughs of the trough structure. Here, it is preferable that cut end surfaces of the horizontal support column and the oblique support column are fixed so as to be abutted to each other. However, the end surfaces may be disposed with a gap therebetween.

Here, by using such the support structure, a direction changing structure for the trough fixing support structure can be obtained without using a separate direction changing member other than the members forming the support structure. Also, an end portion of the direction changing structure to be connected is cut at a predetermined angle being tilted in either the horizontal or vertical direction.

Also, in the trough fixing support structure of the present invention, an invention according to claim 13 is the trough fixing support structure including a direction changing member that guides some of the troughs of the trough structure, which are supported and fixed by the trough fixing support members arranged on the support column structure, toward an arrangement direction of other troughs, which are supported and fixed by the trough fixing support members arranged on a support column structure other than the support column structure.

At this time, the cut end surfaces of the horizontal support column and the oblique support column may be fixed by being abutted to each other, or may be disposed with a gap therebetween. Also, by employing such the structure, the trough structure can be laid being adapted to geographic restrictions of the trough laying site, such as undulations, bends, and connections with underground installations.

In the present invention, although a member that guides a specific trough from the trough structure in a different direction from adjacent troughs is defined as the direction changing member, the direction changing member includes various types of members as described below, such as an upward-downward gradient angle member, a T-shaped branching angle member, a bending angle member, an S-shaped bending angle member, and an inverted S-shaped bending angle member.

In the trough fixing support structure of the present invention, an invention according to claim 14 is the trough fixing support structure including the direction changing structure, in which the direction changing member is either an upward-downward gradient angle member or a T-shaped branching angle member. The direction changing structure using the direction changing member includes a structure that guides the troughs in a different direction in the vertical direction while facing in the same direction in a plan view as the original direction before being connected to the direction changing member, or guides the troughs to branch off in a direction different from the original direction before being connected to the direction changing member. In this way, the trough structure can be laid being adapted to geographic restrictions and branching needs of the trough laying site.

In the trough fixing support structure of the present invention, an invention according to claim 15 is the trough fixing support structure including the direction changing structure, in which the direction changing member is a direction changing member including a bending angle member, an S-shaped bending angle member, and an inverted S-shaped bending angle member, and the direction changing structure using the direction changing member includes a structure that guides the troughs in a curved direction in a plan view different from the original direction before being connected to the direction changing member by using any one of the above direction changing members. In this way, the trough structure can be laid being adapted to geographic restrictions and branching needs of the trough laying site.

In a trough line including the direction changing structure according to the present invention, an invention according to claim 16 is the trough line including a trough fixing support structure. By having a continuous arrangement of troughs (a trough structure) with such the direction changing structure, it is possible to arrange electrical wires and cables inside for transporting electric power or transmitting electrical signals, etc. to where needed, while protecting electric wires and cables inside.

In a method for supporting and fixing a trough structure, which is a second aspect of the present invention, an invention according to claim 17 is a method in which the trough structure includes a support structure that is assembled by using hollow fiber reinforced resin members having a substantially rectangular cross sections as horizontal support columns, oblique support columns, and vertical support columns, and fixing the horizontal or oblique support columns to one or both sides of the vertical support columns, which are buried in the ground or supported and fixed with concrete at predetermined intervals, in one or more tiers with fixing bolts so that the horizontal support columns or oblique support columns are substantially perpendicular or oblique to the vertical support columns.

The support structure further includes a plurality of S-shaped trough fixing support members, each of the plurality of trough fixing support members is configured such that an inverted U-shaped first fixing portion and a normal U-shaped second fixing portion are integrally connected to each other, and the inverted U-shaped first fixing portions are hooked and fixed onto the horizontal support columns or the oblique support columns, and a trough structure in which a plurality of troughs are continuously disposed is placed on the normal U-shaped second fixing portions of the plurality of trough fixing support members so that the trough structure is supported by the trough fixing support structure. This method can greatly increase degree of freedom in arrangement of the trough fixing support members, and allows the troughs to be installed easily and stably.

In the method for supporting and fixing the trough structure, an invention according to claim 18 is the method in which the metal-made or resin-made trough structure, which is subjected for adding, removing, and maintaining cables disposed in the metal-made or resin-made trough structure, is supported by the trough fixing support structure by adjusting tightening level of a bolt and a nut that fix the inverted U-shaped first fixing portion mounted on the horizontal support column or the oblique support column, of the trough fixing support member. This makes it easier to perform maintenance such as adding or removing cables without any hassle.

In a trough fixing support member, which is a third aspect of the present invention, an invention according to claim 19 is an S-shaped trough fixing support member. The trough fixing support member includes an inverted-U-shaped first fixing portion and a normal U-shaped second fixing portion, in which the first fixing portion has two holes provided at mutually opposing and symmetrical positions at parts extending to a lower side below a horizontal support column or oblique support column when the inverted U-shaped first fixing portion is mounted on the horizontal support column or the oblique support column, such that a bolt can be inserted into the two holes and tightened with a nut, and the second fixing portion, which is a U-shaped opening further beyond the first fixing portion, has a structure on which a metal-made or resin-made trough structure can be placed.

The trough fixing support member of the present invention allows the bolt to be passed through the two holes and the nut to be tightened, eliminating a need to drill holes in the horizontal support column, thereby greatly increasing freedom of installation location of the member on the support structure and enabling easy and stable installation of the trough.

Here, although the trough fixing support member of the present invention is usually made of a metal material such as aluminum, materials such as fiber-reinforced resin and engineering plastics may also be used.

Also, in the trough fixing support member of the present invention, an invention according to claim 20 is the trough fixing support member in which, when the trough fixing support member used for a solid support column is attached to the horizontal support column or oblique support column having a solid structure with substantially rectangular cross section, since the support column is attached with a long side of the solid structure as an attaching surface, an inner surface width of the inverted U-shaped first fixing portion is substantially equivalent to a short side of the solid structure with the substantially rectangular cross section and a length of the U-shaped first fixing portion is formed into a size that bolt holes can be provided at parts extending to a lower side below the long side of the cross section of the horizontal support column or oblique support column.

In this way, even when the support column made of a solid fiber-reinforced resin member is used, the trough structure can be stably supported by the second fixing portion by making the attachment surface the long side of the substantially rectangular shape and making the width of the short side of the solid structure substantially equal to the width of the first fixing portion.

Also, another embodiment of the trough fixing support structure of the present invention includes a support column structure that stands on a fixed surface and is formed by combining a plurality of fiber-reinforced resin members, a support structure having a trough fixing support member that is detachably fixed to the support column structure, and resin-made troughs that are fixed to the trough fixing support member and are arranged and installed being separated away from the fixed surface. In this way, leakage of electricity can be efficiently suppressed by being separated from the fixed surface. At this time, it is preferable that the trough fixing support member includes a hook shape that can be detachably fixed to the fiber-reinforced resin member.

By using the trough fixing support structure of the present invention, it is possible to realize a trough fixing support structure in which troughs are arranged in multiple tiers, and further to realize a trough line having a direction changing structure using direction changing members. According to the present invention, by adopting a novel trough fixing support member, the degree of freedom in the position where the trough fixing support member is hooked to the horizontal support column is increased, and the troughs can be stably placed and fixed with simple attachment. Furthermore, if necessary, bolt holes can be provided at opposing positions of the trough fixing support member at a lower part of the trough fixing support member and beyond the horizontal or oblique support column, and, since the trough fixing support member is fixed with bolts and nuts without drilling holes in the support column, the trough fixing support member can be attached to anywhere on the horizontal or oblique support column and it is easy to attach the trough fixing support member, thereby greatly increasing freedom and stability thereof.

### BRIEF DESCRIPTION OF DRAWINGS

FIG. 1 is a perspective view schematically showing an overall configuration of a trough fixing support structure including trough fixing support members, in which horizontal support members substantially orthogonally intersect with vertical support columns.

FIG. 2 is a perspective view schematically showing an overall configuration of the trough fixing support structure including the trough fixing support members, in which the horizontal support members substantially orthogonally intersect with vertical support columns and oblique support columns obliquely intersect with the vertical columns.

FIG. 3 is a perspective view showing an enlarged view of a region III in FIG. 1.

FIG. 4A is a cross-sectional arrow view taken along IV-IV line shown in FIG. 3, and shows an overall structure with a resin-made trough installed.

FIG. 4B is a partial cross-sectional view showing a case where the trough fixing support member and a trough bottom portion are fixed to each other with a bolt at the bottom portion of the trough in region B in FIG. 3.

FIG. 4C is a partial cross-sectional view showing an example of fixing a trough lid to a trough body in region C in FIG. 3.

FIG. 5A is a cross-sectional view of a hollow support column made of fiber-reinforced resin member.

FIG. 5B is a cross-sectional view of a solid support column made of fiber-reinforced resin member.

FIG. 6 is a cross-sectional view showing an example of a support structure in which a resin-made trough is supported on the solid horizontal support column and/or oblique support column made of fiber-reinforced resin member by using the trough fixing support member.

FIG. 7 is a cross-sectional view schematically showing a schematic view of FIG. 4A when a metal-made trough is placed instead of the resin-made trough.

FIG. 8 is a cross-sectional view schematically showing a schematic view of FIG. 4A when a substantially C-shaped support base is applied.

FIG. 9 is a cross-sectional view schematically showing a schematic view of FIG. 4A when a flat-plate-shaped support base is applied.

FIG. 10 is a side view schematically showing positions for disposing the trough fixing support members to the trough structure.

FIG. 11 is a side view schematically showing other positions for disposing the trough fixing support members to the trough structure.

FIG. 12 is a cross-sectional view schematically showing a state in which the resin-made troughs are disposed in multiple tiers on one side in the trough fixing support structure.

FIG. 13 is a cross-sectional view schematically showing a state in which the resin-made troughs are disposed in multiple tiers on both sides in the trough fixing support structure.

FIG. 14 is a side view schematically showing the trough fixing support structure in which direction of the trough structure is changed from the horizontal support column to the oblique support column disposed obliquely so as to be continuous to underground installation.

FIG. 15 is a perspective view schematically showing an upward-downward gradient angle member.

FIG. 16 is a side view showing a connected state of the resin-made troughs in which the upward-downward gradient angle member is applied.

FIG. 17 is a perspective view schematically showing a T-shaped angle member.

FIG. 18 is a perspective view schematically showing a C-shaped bending angle member.

FIG. 19 is a drawing showing a structure of a bridge pier.

FIG. 20 is a perspective view schematically showing an S-shaped bending angle member.

FIG. 21 is a side cross-sectional view schematically showing an aspect in which a T-shaped branching trough is installed.

FIG. 22 is an exploded perspective view schematically showing an aspect in which the T-shaped branching trough is installed.

FIG. 23 is a perspective view schematically showing a shape of a bent trough.

FIG. 24A is a perspective view schematically showing an upward-downward gradient trough.

FIG. 24B is a perspective view schematically showing an upward gradient trough.

FIG. 24C is a perspective view schematically showing a downward gradient trough.

### DETAILED DESCRIPTION OF SOME EMBODIMENTS

A trough fixing support structure according to a preferable embodiment of the present invention includes a support column structure including a horizontal support column and/or an oblique support column, and a vertical support column. The support column structure includes a plurality of S-shaped trough fixing support members (preferably trough fixing support fittings). Each of the S-shaped trough fixing support members includes an inverted U-shaped first fixing portion and a normal U-shaped second fixing portion, which are continuously connected with each other. The inverted U-shaped first fixing portion is hooked onto the horizontal support column and/or the oblique support column to be fixed. Meanwhile, a trough can be placed on the normal U-shaped second fixing portions. Hereinafter, the trough fixing support structure according to the preferable embodiment of the present invention will be described in detail with reference to the accompanying drawings.

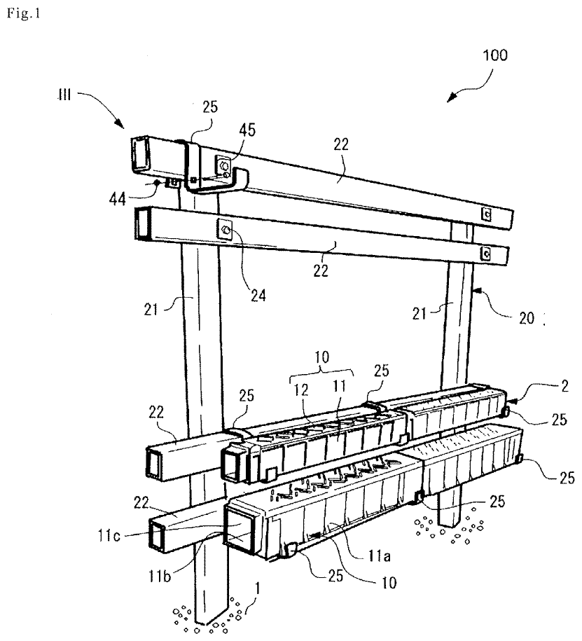

FIG. 1 is a perspective view schematically showing an overall configuration of a trough fixing support structure 100 including a trough fixing support member 25 according to the present embodiment.

The trough fixing support structure 100 includes a support column structure 20 having a vertical support column 21 and a horizontal support column 22, and the trough fixing support member 25.

In the support column structure 20 of the trough fixing support structure 100, the vertical support column 21 that extends upward from a ground or a concrete foundation 1 (a fixed surface) is installed. The vertical support column 21 is made of a hollow fiber-reinforced resin member with a substantially rectangular cross section. The four horizontal support columns 22 are installed and fixed to the vertical support column 21 by support column fixing members 24. The support column fixing member 24 may be of any type, but is preferably composed of a bolt and a nut.

Similarly to the vertical support column 21, the horizontal support column 22 is also made of a hollow fiber-reinforced resin member with a substantially rectangular cross section. In this way, the vertical support column 21 and the horizontal support column 22 are assembled to intersect substantially orthogonally by using the support column fixing members 24 to form the support column structure 20. Here, “to intersect substantially orthogonally” is meant to include intersection at 90° as well as aspects of installation with a slight additional angle depending on topographical features or structure etc. of the installation site, including, for example, aspects of assembly with angles between 85° and 95° as necessary. When a support column is attached to the vertical support column so as to intersect at an inclination angle outside of the above-mentioned substantially orthogonal angle, this will be referred to as oblique intersection.

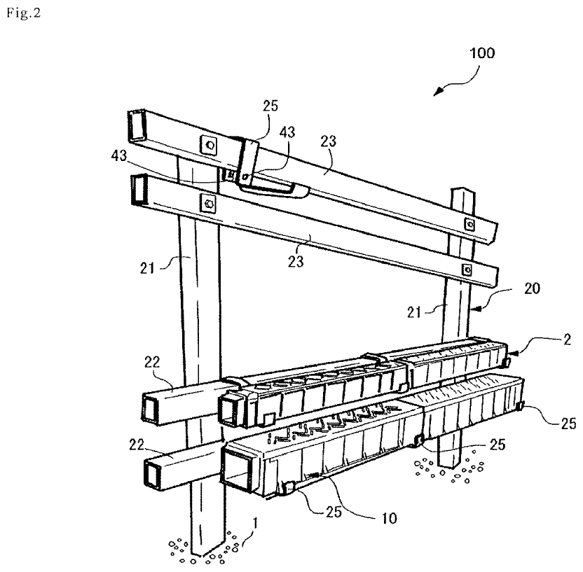

FIG. 2 shows the trough fixing support structure 100 including the support column structure 20 in which the two lower horizontal support columns 22 are fixed to the vertical support columns 21 so as to substantially orthogonally intersect with the vertical support columns 21 and two upper oblique support columns 23 are fixed to the vertical support columns 21 so as to intersect obliquely with the vertical support columns 21. In this way, depending on the need for the support columns to be attached to the vertical support columns, a support structure may have the support column structure including the horizontal support columns attached orthogonally, or the support structure may have the support column structure partly including the oblique support columns 23 that intersect obliquely. Alternatively, although not particularly shown, all the support columns may be formed of the oblique support columns 23 instead of the horizontal support columns, and the support structure may have the support column structure with oblique intersection to the vertical support columns.

In the support column structure 20, it is preferable that the hollow fiber-reinforced resin member with the substantially rectangular cross section forming the horizontal support column 22 and the vertical support column 21 is a fiber-reinforced resin composite material. As a base resin material that can be applied to the hollow fiber-reinforced resin member, both thermoplastic resin and thermosetting resin can be used. As the thermoplastic resin, polypropylene resin, ABS resin, PC resin, PBT resin, PPO resin, and PA resin can be used. However, if there is no problem in terms of cost, other engineering plastics, such as PI resin, PAI resin, PPS resin, PEN resin, and PEEK resin may also be used.

Also, as the thermosetting resin, urethan resin and epoxy resin can be used. As fibers to form the fiber-reinforced resin composite material, glass fiber is used. The glass fiber used here may be short fiber, filament, or continuous filament. However, it is preferable to form the fiber-reinforced composite member by extrusion such that the spun continuous filament is wound at a predetermined angle to be arranged as a continuous body. To prevent decrease in strength due to glass surface deterioration, glass to be used as an ingredient is preferably E glass, which is an inorganic alkaline glass such as quartz glass.

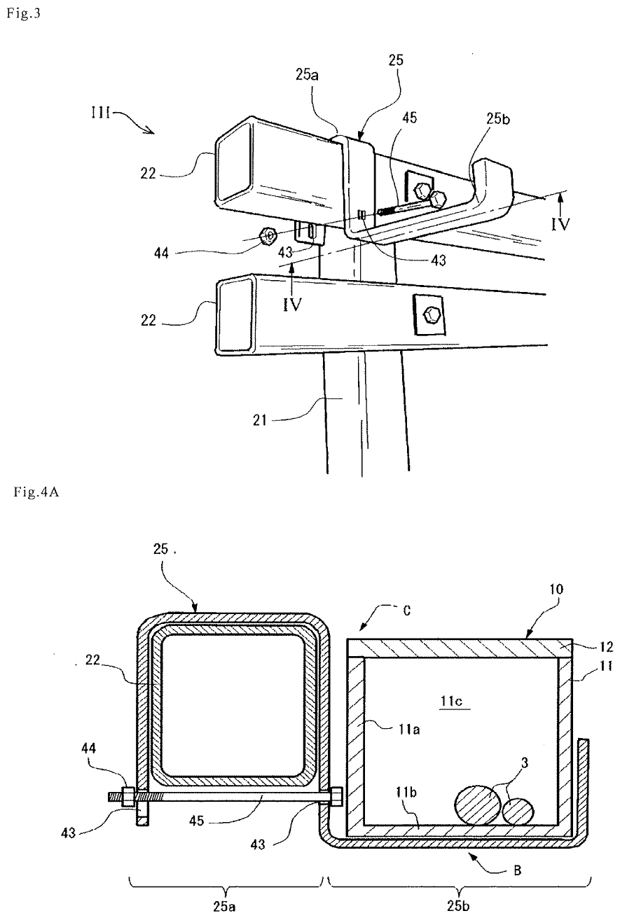

FIG. 3 is an enlarged perspective view showing a region III in FIG. 1. The trough fixing support member 25 of the present embodiment has an S-shaped overall form in which U-shapes are combined in different directions. As shown in the drawing, the trough fixing support member 25 includes an inverted U-shaped first fixing portion 25a and a normal U-shaped second fixing portion 25b, which are connected to be continuous with each other. The inverted U-shaped first fixing portions 25a can be hooked and fixed onto the horizontal support column 22.

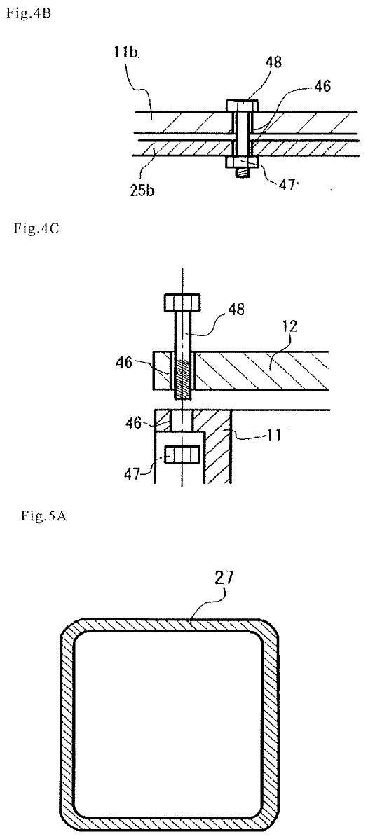

FIG. 4A is a vertical cross-sectional arrow view taken along IV-IV line in FIG. 3, with a resin-made trough being placed. Specifically, a trough 10 including an electric cable 3 is placed on the normal U-shaped second fixing portion 25b.

The trough 10 is made of resin and includes a trough body 11 and a trough lid 12, which can be placed and fixed onto the trough body 11. The trough body 11 is shaped to have a substantially U-shaped cross section formed by a bottom plate 11b and side plates 11a standing substantially vertically on both sides of the bottom plate 11b. An interior space of the substantially U-shaped cross section is to be a storage 11c for the electric wire or cable 3. Here, a vertical rib directing to an upper part of the side plate may be formed at an outer surface of the side plate 11a of the trough body to reduce weight and improve strength, and a horizontal rib having a predetermined length may be formed on a predetermined position of the side plate 11a to fix the trough lid 12. Also, an upper surface of an upper end of the resin-made side plate 11a is covered with the trough lid 12, and the upper surface of the trough lid 12 may be formed with a protruding pattern (protrusions) to prevent slipping, and on both widthwise sides of the back surface of the trough lid 12, protrusions or ribs that fit inside the side plates may be formed to prevent displacement.

Furthermore, as described below, a male portion 15 and a female portion 16 are formed at a tip end and a rear end of a longitudinal direction of the trough body 11, respectively.

As shown in FIG. 3 and FIG. 4A and FIG. 4B, two screw holes 43 are drilled on opposing side surfaces that correspond to the first fixing portion 25a of the trough fixing support member 25. The screw holes 43 are located further beneath a bottom portion of the horizontal support column 22 that is being hooked on. A bolt 45 can be inserted through the screw holes 43 to be protruded from the screw hole on the opposite side so as to be tightened by a nut 44. In other words, the two holes 43 are provided at mutually opposing and symmetrical positions at parts extending below the horizontal support column 22 so as not to obstruct the insertion of the bolt 45, and the bolt 45 is inserted into the two holes and tightened with the nut 44.

This enables to tighten and fix the trough fixing support member 25 to the horizontal support column 22. In this way, in the present embodiment, there is no need to provide a hole in the horizontal support column 22 for fixing by the bolt 45 and the nut 44, and thus the trough fixing support member 25 can be tightened, arranged freely and easily, and fixed to any position of the horizontal support column 22 where there is no interference with the vertical support column 21.

Also, tightening level can also be adjusted as appropriate, and it is possible to set the suitable tightening level depending on the material or shape of the horizontal support column 22. This makes the trough fixing support member 25 detachable with respect to the support column structure 20. Material for the trough fixing support member 25 is not particularly limited, and, from a viewpoint of obtaining rigidity, impact strength, and corrosion resistance, the trough fixing support member 25 is preferably made of aluminum or the like, or may be made of a fiber-reinforced resin composite material. The above-mentioned aspect of attaching the trough fixing support member 25 and tightening and fixing with bolts and nuts through holes can also be applied to the oblique support columns 23 shown in FIG. 2.

FIG. 4B is a partial cross-sectional view showing an aspect in which the screw hole 46 is drilled at a position of a region B in FIG. 4A and fixed with the bolt 48 and the nut 47. In the trough fixing support structure according to the present embodiment, to fix the mounted trough 10 more stably, it is preferable to provide a screw hole in the trough fixing support member to be fixed being aligned with a screw hole on the trough side as shown in the same drawing. Even when aligning the screw holes, the trough fixing support member 25 of the present embodiment is movable, thereby facilitating alignment of the holes.

FIG. 4C shows a configuration in which the trough lid 12 is placed on the trough body 11 in area C of FIG. 4A and fixed by tightening one of the four corners of the lid with the bolt 48 and the nut 47. A fastening structure similar to the one shown in the drawing is arranged at four corners of the lid, and by tightening the bolts at the four corners of the lid, the trough lid 12 is prevented from coming off easily, and the form of the resin-made trough 10 is stably maintained even against pressure such as wind. Although not particularly shown, the trough lid may be fixed with a buckle attached to the trough body instead of being tightened by the bolts.

FIG. 5A and FIG. 5B are views comparing a support column cross section of a hollow support column 27 made of a fiber-reinforced resin member with a support column cross section of a solid support column 26 made of a fiber-reinforced resin member, where the hollow support column 27 and the solid support column 26 can configure the support columns such as the vertical support column 21, the horizontal support column 22, and the oblique support column 23 forming the support column structure 20 shown in FIG. 1 and FIG. 2 etc. As shown in FIG. 5A, there is no big difference between a length of the long side and a length of the short side of the substantially square or rectangular shape. On the other hand, as shown in FIG. 5B, for the cross-sectional shape of the fiber-reinforced resin member of the solid support column 26, a ratio of the length of the long side to the length of the short side is changed significantly. Thus, when the solid fiber-reinforced resin member is used as the support column, considering stability as a structure after such the member is attached to the vertical support column 21, the horizontal support column 22 or the oblique support column 23 is abutted against the vertical support column 21 and fixed with the long side of the cross section thereof being oriented in a vertical direction. Furthermore, the trough fixing support member is placed over the long side of the horizontal support column 22 or the oblique support column 23, and is then bolted to abut against a long side of the first fixing portion 25a of the trough fixing support member 25 to be used, as described below.

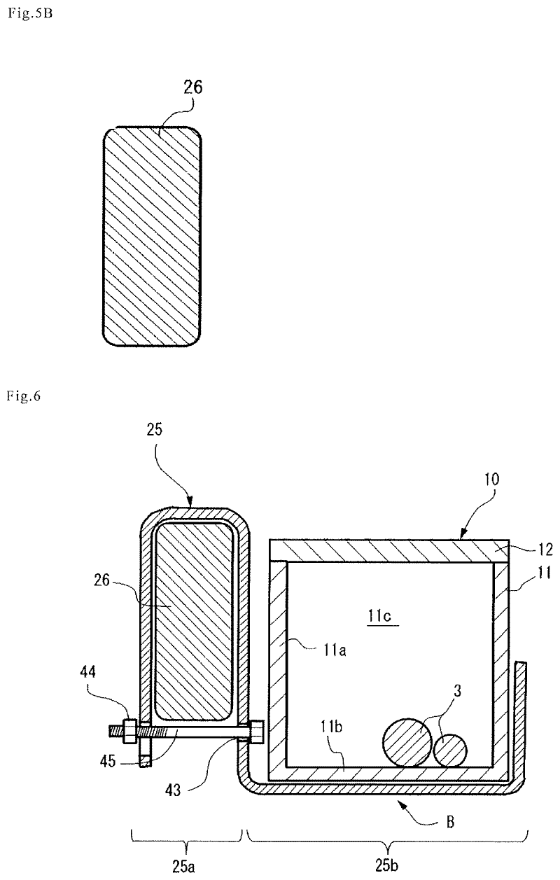

FIG. 6 is a cross-sectional view showing an example in which the trough fixing support member 25 is installed on the horizontal support column 22 and/or the oblique support column 23 formed of the solid support column 26 made of the fiber-reinforced resin member, and the resin-made trough 10 is supported on the trough fixing support member 25. Here, when the fiber-reinforced resin member of the solid support column 26 is used as the support column, the inverted U-shaped first fixing portion 25a is arranged striding over the horizontal support column and/or the oblique support column, similarly as in the case in which the hollow support column 27 is used. Then, the trough 10 can be placed on the normal U-shaped second fixing portion 25b of the trough fixing support member.

At this time, a width of the support column 26 having the solid cross section is smaller than a width of the support column 27 having the hollow cross section. Thus, only a width of the inverted U-shaped first fixing portion 25a of the S-shaped trough fixing support member 25 becomes smaller. Otherwise, if dimensions of the trough 10 to be placed in the second fixing portion 25b are similar, dimensions of the second fixing portion 25b are similar to those in the case of using support column with the hollow cross-section. That is, when using the solid support column 26, the dimensions of the trough fixing support member 25 remain the same except that inner dimension in the width direction of the first fixing portion 25a becomes shorter.

As above, it is possible to configure the trough fixing support structure 100 including the support column structure 20, which is configured by combining the plurality of hollow fiber-reinforced resin members and stands on the fixed surface, and the trough fixing support members 25, which are fixed detachably to the support column structure 20, and a trough structure 2 including the resin-made troughs 10 that are fixed to the trough fixing support members 25 and are arranged to be away from the fixed surface. In this way, leakage of electricity can be efficiently suppressed by being separated from the fixed surface.

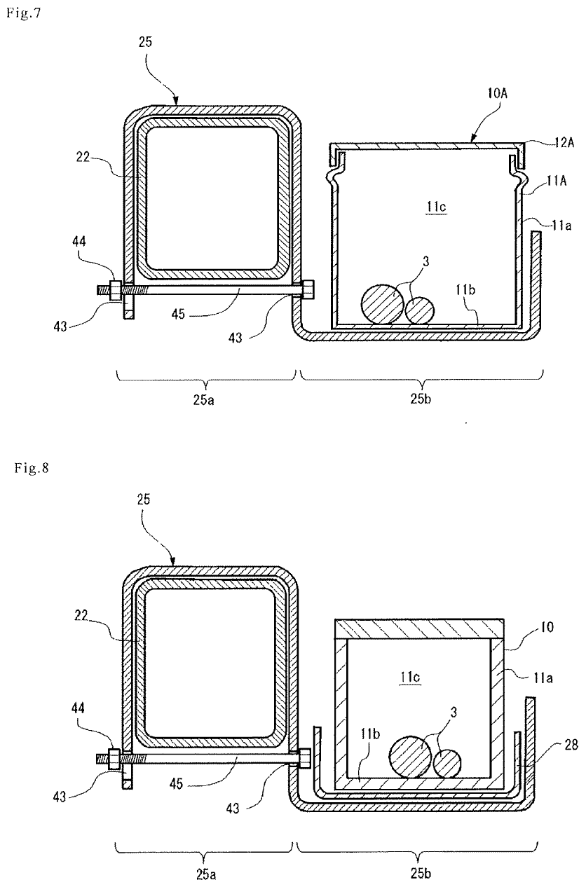

FIG. 7 is a cross-sectional view schematically showing a structure in which a metal-made trough is placed in place of the resin-made trough, as viewed in FIG. 4. In other words, FIG. 7 is a cross-sectional arrow view taken along IV-IV line in FIG. 3, schematically showing a state in which a metal-made trough 10A is placed on the trough fixing support member 25. As shown in the present embodiment, thicknesses of a metal trough body 11A and a metal trough lid 12A are slightly smaller compared to those of the resin-made trough.

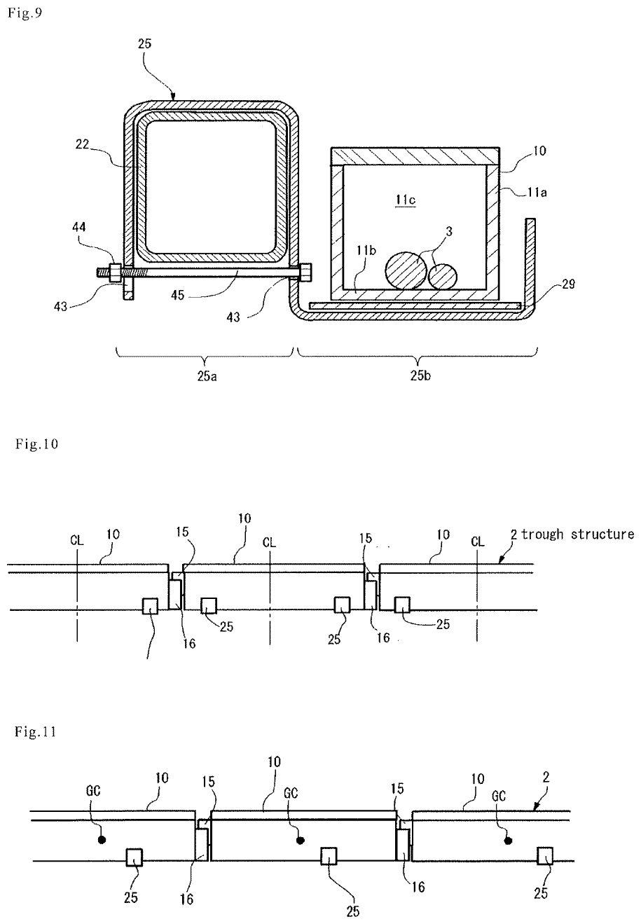

FIG. 8 is a cross-sectional view schematically showing a state in which a substantially C-shaped support base 28 is applied to the trough fixing support member 25. Also, FIG. 9 is a cross-sectional view schematically showing a state in which a flat-shaped support base 29 is applied to the trough fixing support member 25.

As shown in the drawings, the support bases 28 or 29 has a cross-sectional shape that fits inside the normal U-shaped second fixing portion 25b of the trough fixing support member 25 and that the trough 10 fits inside, and has a shape that is as long as the horizontal support column 22 in a longitudinal direction (in a direction perpendicular to a plane of the paper in FIG. 8 and FIG. 9). The second fixing portion 25b and the second fixing portion 25b are disposed at different positions in the longitudinal direction and the support base 28 or the support base 29 is placed and fixed on both of the second fixing portions 25b. The trough bottom plate 11b of the trough 10 is further disposed thereon. In this way, the support base 28 or 29 allows the trough 10 to be placed and fixed more stably over the longitudinal direction.

As for the number of trough fixing support members 25 used when the support base 28 or 29 is employed, it is preferable to employ a couple of the trough fixing support members 25 for the one support base 28 or 29. The reason for this is that it is more stable to support the one support base from both sides with the two or more trough fixing support members 25. Although non-limiting materials with predetermined strength and corrosion resistance may be used for the support bases 28 and 29, it is preferable that the support bases 28 and 29 are made of resin, aluminum, galvanized steel plate, or the like.

Although the trough 10 may be made of any material and may be in any shapes in the present embodiment, a shape of commonly commercially available products is assumed in the present embodiment. For example, although a resin-made material is preferable, a metal-made material may also be used. For the resin-made material, taking a viewpoint of environmental protection, recycled polyethylene may be used, for example. For the metal-made material, galvanized steel plates, for example, are economical and have advantages of being easy to work with, lightweight, and resistant to corrosion.

The trough 10, as described based on FIG. 1, FIG. 3, and FIG. 4, includes the bottom plate 11b and the side plates 11a extending upward from both sides of the bottom plate 11b, forming the trough body 11 having a substantially U-shaped cross section. The trough 10 is configured by the trough body 11 and the trough lid 12 placed thereon. The troughs 10 are closely disposed so as to form a joint structure (a trough structure) extending in the horizontal direction, that can store the electric wire or cable 3 in the storage 11c.

Similarly to the trough body 11, the trough lid 12 is normally made of resin. The trough lid can be fixed with a buckle, which is not shown, attached to the horizontal rib on a trough side wall to a buckle fixing portion on the trough lid. Alternatively, as described above based on FIG. 4C, the bolt 48 may be inserted through the screw hole 46 provided on the trough lid 12 and then the bolt 48 is further inserted into the screw hole 46 of the horizontal rib provided on an outer side surface of the side wall at a rear end of the trough to fix a tip of the bolt 48 with the nut 47.

In other words, the continuous arrangement (the trough structure) 2 of the troughs 10 is formed of either a male-female joint structure of the adjacent troughs 10 or a close-arrangement of the troughs having only the trough storages, without the male-female structure, and the matching trough lids. The either of the troughs are placed on the second fixing portions 25b of the S-shaped trough fixing support members 25. There may be any number of the trough fixing support members 25. However, considering an economical view point, it is preferable that one or two of the trough fixing support members 25 are provided for each trough.

The above descriptions are mainly on the embodiments in which the horizontal support columns 22 are used as the support columns. However, similar descriptions including the relationship between the troughs 10 and the trough fixing support members 25 may also be applied to the oblique support columns 23, and are not to be interpreted as being limiting in any way.

FIG. 10 is a side view schematically showing positions where the trough fixing support members are to be disposed with respect to the troughs. In the present embodiment, the troughs 10 to be placed on the trough fixing support members 25 form the trough structure 2 in which the troughs 10 having the same cross sections are closely disposed. The present embodiment shows an example in which the two trough fixing support members 25 are disposed symmetrically with respect to a centerline CL at front and rear end portions of the one trough 10. In this way, the troughs 10 can be stably placed.

Furthermore, FIG. 11 is a side view schematically showing other positions where the trough fixing support members are to be disposed with respect to the troughs 10. In the present embodiment, the one trough fixing support member 25 is disposed in the longitudinal direction of the trough 10 for each trough. In such the case, it is preferable to support a position that is a predetermined distance away from a center of gravity GC of the trough 10 in the longitudinal direction on a side of the female joining structure (female portion) 16. By disposing the trough fixing support members 25 at such the position, weight on a side of the male portion of the adjacent trough can be supported through the female portion of the supporting member, thereby, as a result, achieving an embodiment with the one trough fixing support member for each trough.

As above, by supporting the position that is the predetermined distance away from the center of gravity toward the female portion side, the trough structure (continuous arrangement of troughs) 2 has an advantage that a greater number of troughs can be stably supported and fixed with a smaller number of the trough fixing support members 25.

The trough 10 of this embodiment has a trough body 11 having a substantially U-shaped cross section and is covered and fixed with the trough lid 12. Furthermore, the continuous arrangement (the trough structure) 2 of the troughs 10 is formed of either the male-female joint structure of the adjacent troughs 10 or the close-arrangement of the troughs having only the trough storages 11c without the male-female structure and the matching trough lids 12. At this time, the either of the troughs are placed on the second fixing portions 25b of the S-shaped trough fixing support members 25.

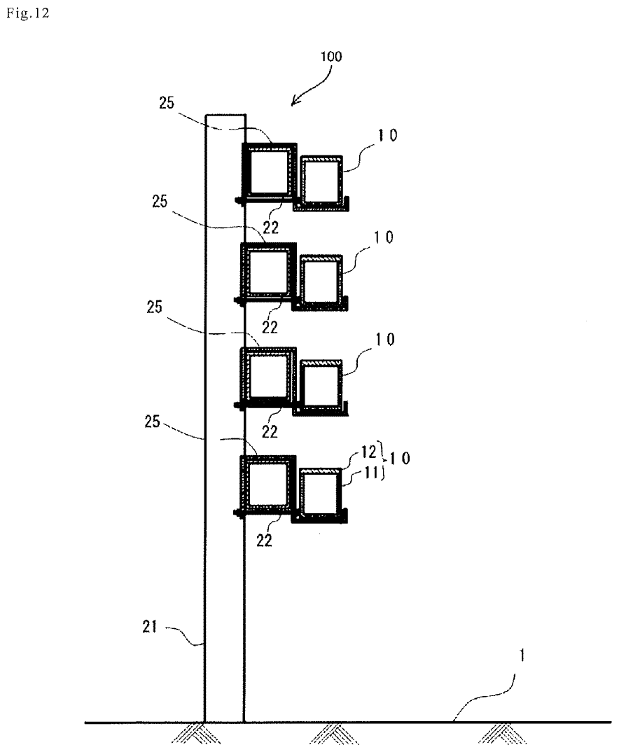

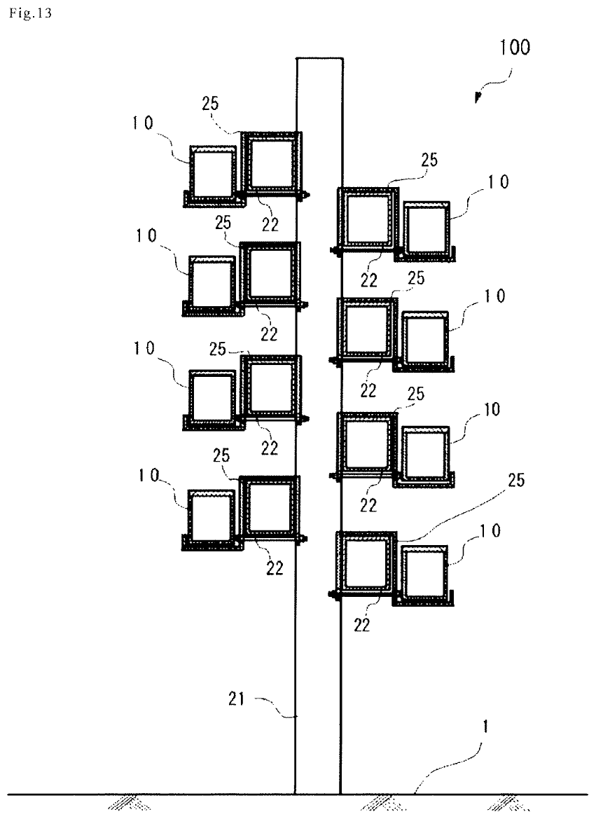

FIG. 12 is a cross-sectional view schematically showing a state of the trough fixing support structure in which the resin-made troughs are disposed in multiple tiers (four tiers in the drawing) on one side of the vertical support columns 21. In the present embodiment, a plurality of the horizontal support columns 22 are installed in multiple rows on one side of the vertical support columns 21 that extend upward from the ground 1 (or may be a concrete foundation). The trough fixing support members 25 are installed, being arranged in multiple tiers, onto the horizontal support columns 22.

Furthermore, FIG. 13 is a cross-sectional view schematically showing a state of the trough fixing support structure in which the resin-made troughs are disposed in multiple tiers on both sides of the vertical support columns 21. In the present embodiment, the horizontal support columns 22 are arranged on both sides with respect to the vertical support columns 21. In the drawing, horizontal support columns 22 are arranged on the left and right. In this way, applying the load on one side of the vertical support columns 21 is avoided, and the trough fixing support structure 100 is fixed being well-balanced to the ground or concrete foundation.

The trough fixing support members are provided on the horizontal support columns 22 on the left and right, and the troughs are placed on the normal U-shaped second fixing portions thereof. The present embodiment is preferable in that it is possible to efficiently extend multiple electric wires with a support body of the small number of the support columns. At this time, the present embodiment has an advantage that the freedom of installation positions of the trough fixing support members 25 is high, and is preferable in that stability of the trough fixing portions (the second fixing portions) can be realized. Although the above descriptions are on the embodiment based on FIGS. 10 and 11 in which the horizontal support columns 22 are used, similar descriptions may also be applied to the case with the oblique support columns 23, and are not to be interpreted as being limiting in any way.

As described above, the present embodiment can provide the trough fixing support structure 100 including the support column structure 20, which is configured by combining the plurality of fiber-reinforced resin members and stands on the fixed surface, and the trough fixing support members 25, which are fixed detachably to the support column structure 20, and a trough structure including the resin-made troughs 10 that are fixed to the trough fixing support members 25 and are arranged to be separated away from the ground or the concrete foundation 1, which is a fixing surface. Furthermore, the trough fixing support member 25 has a hook shape that can be detachably fixed onto the fiber-reinforced resin members. As a result, by combining support columns made of fiber-reinforced resin members, the troughs 10 can be installed in multiple tiers in a direction perpendicular to the ground, making it possible to lay multiple troughs 10 without spreading the troughs 10 as much as possible in the width direction of the trough path. In addition, since the support columns are fiber-reinforced members, a risk of electrification can be suppressed even without earthing, and components are all light weighted, thereby providing the trough structure with excellent workability. In particular, when the troughs 10 are made of resin, which is preferable, the number of troughs 10 installed with respect to the support column structure 20 can be significantly greater than in the case of metal-made troughs.

Although the troughs 10 are disposed straightly on a straight line in the longitudinal direction in the above embodiments, it is also possible to adopt following direction changing structures.

### (Example of Upward-Downward Gradient Structure)

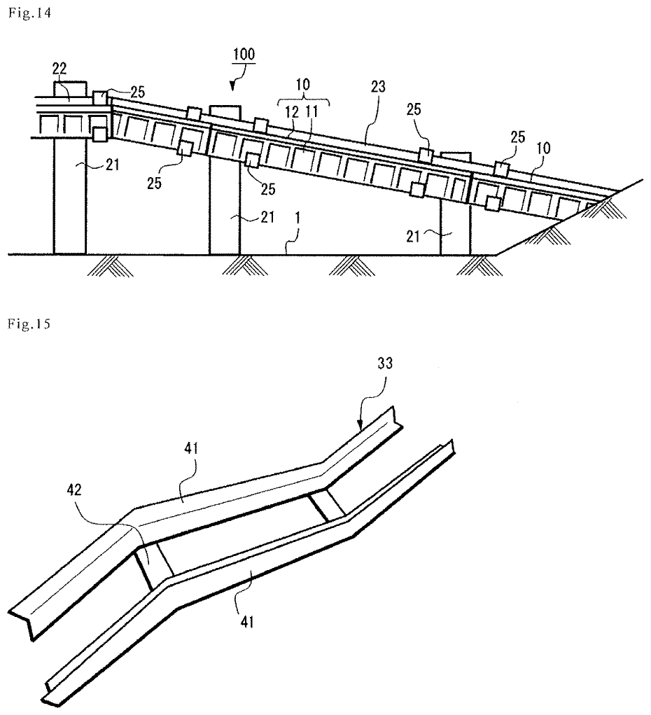

FIG. 14 is a side view schematically showing the trough fixing support structure 100 having a direction changing structure in which direction of the trough structure 2 is changed from a horizontal arrangement to an oblique direction so that the troughs 10 are eventually buried underground.

In the trough fixing support structure of the present embodiment, the vertical support columns 21 are arranged vertically to the ground, and the oblique support column 23 is installed obliquely inclining to the horizontal direction intersecting perpendicularly to the vertical support columns 21. An angle of inclination may be appropriately chosen according an inclination of the ground for assembly.

Also, the horizontal support column 22 as a supporting member connecting the two vertical support columns 21 may be fixed to the vertical support columns 21 simply by welding or screwing, or may be fixed rotatably to the vertical support columns 21. The trough bridge is normally used with the vertical support column being buried underground.

Here, the trough bridge is formed as an H-shaped or two-tier ladder-shaped bridge including two parallel support columns that also serve as support piles, connected at right angles to each other at a predetermined height by one or two support members with substantially rectangular cross sections. The trough bridge is normally used with the support column being buried underground. For example, representative structures of the trough bridge are disclosed in JP-A-2018-33195, JP-A-2008-236830, and JP-A-2015-142387. The trough bridge may also have a slightly different structure with the similar function as above, using vertical columns buried in the ground and supporting various angle members. For example, a bending angle may be supported on an upper support member of the support member of the trough bridge.

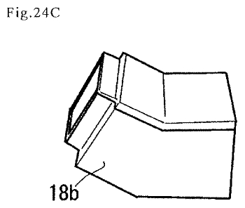

FIG. 15 is a perspective view schematically showing an upward-downward gradient angle member 33. The angle member 33 allows the troughs 10 to be adopted to a configuration having an up-down gradient and arranged in a shape that conforms to the configuration. The upward-downward gradient angle member 33 is a member used when there is a gradient in the vertical direction and an angle or level difference adjustment is necessary. For such the upward-downward gradient angle member 33, either a combination of an upward gradient trough 18a having a protruding bent path on an upper side of the trough as shown in FIG. 24B and a downward gradient trough 18b having a path that is bent in an opposite direction to the upward gradient trough 18a as shown in FIG. 24C, or an upward-downward gradient trough 18, which is shown in FIG. 24A and is configured by cutting a normal trough so as to adapt a cross section thereof to an angle of the angle member (not shown), may be used (a notation A in the drawing is an auxiliary line showing a border between the upward gradient trough 18a and the downward gradient trough 18b.

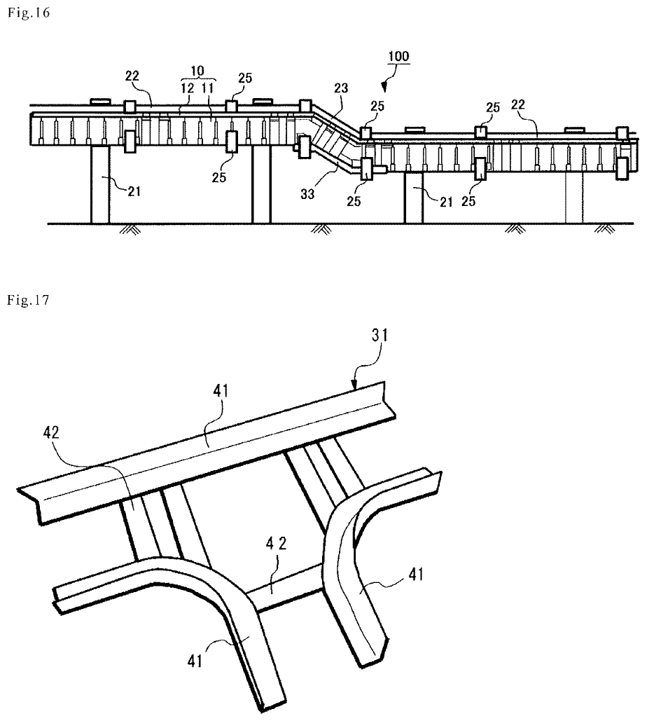

FIG. 16 shows the trough fixing support structure including a direction changing structure in which the upward-downward gradient angle member 33 is used as a direction changing member to guide downward the structure of the trough 10, which is supported and fixed to the horizontal support columns 22 by the trough fixing support members 25.

The similar direction changing structure can be also obtained by directly fixing a parallel angle member, which is bolted to the horizontal support columns 22 fixed to the vertical support columns 21, to the upward-downward gradient angle member 33, or by fixing the parallel angle member and the upward-downward gradient angle member 33 to the trough bridge instead of the horizontal support columns 22.

### (Example of T-Shaped Branching Structure)

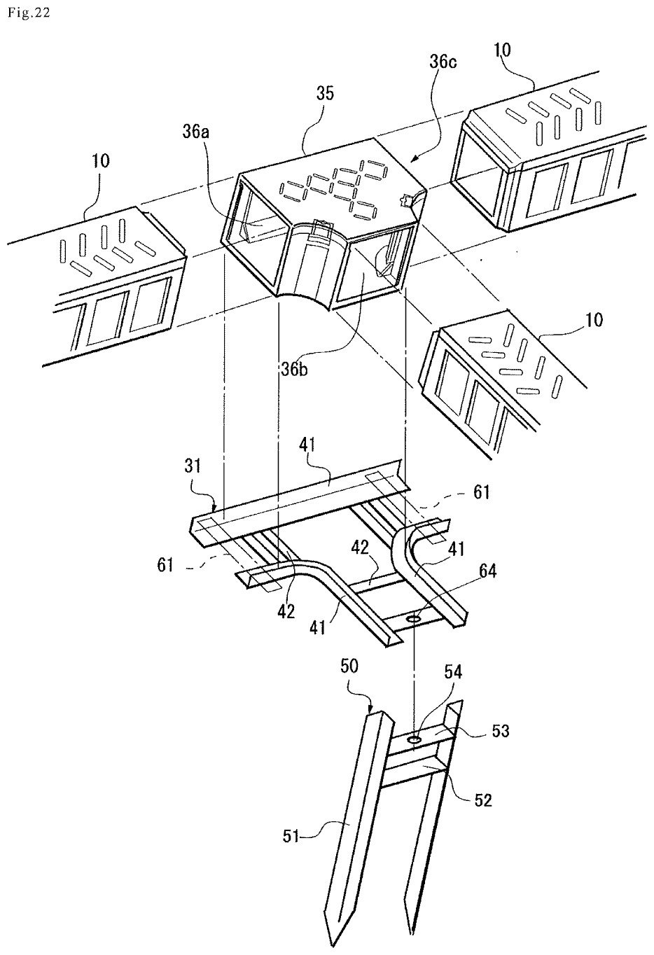

FIGS. 21 and 22 are schematic views showing a structure in which the troughs can be branched into a T shape in the trough fixing support structure, wherein FIG. 21 is a side view and FIG. 22 is an exploded view of parts before assembling.

As shown in FIGS. 21 and 22, in the trough fixing support structure 100 similar to that shown in FIG. 1, etc., a T-shaped angle member 31 is fixed to the two trough fixing support members 25, and a trough bridge pier 50 is disposed and fixed to a lower part of the T-shaped branching angle member 31, and the trough bridge pier 50 is fixed standing upright on the ground. In this way, the T-shaped branching angle member 31 is stably supported and fixed in the trough fixing support structure 100. In addition, a T-shaped branching trough 35 is placed on the T-shaped branching angle member 31. The T-shaped branching trough 35 has openings 36a, 36b, and 36c that are formed in three directions, respectively, and another trough is fixed to each of the openings so as to form a continuous trough structure. An area 61 of the T-shaped branching angle member 31 shows an example of a part on which the trough fixing support member 25 may be disposed and supported.

FIG. 17 is a perspective view schematically showing an example of the T-shaped branching angle member 31. With such the angle member, in the trough fixing support structure 100, the troughs supported and fixed by the trough fixing support members 25 to any horizontal or oblique support columns of the support column structure 20 can be branched by the direction changing member. Similarly, for such the member, at least a part of the T-shaped branching angle member 31 and the side of the horizontal or oblique support column can be fixed with each other by bolting, or the T-shaped branching angle member 31 can be supported and fixed by the trough bridge or the like. The T-shaped branching trough 35 can be placed on such the member to be fixed.

The T-shaped branching trough 35 being placed on the T-shaped branching angle member 31 and supported and fixed to the horizontal columns, the oblique support columns, or the trough bridge is not specifically shown in the drawing. However, the T-shaped branching trough 35 can be placed on the T-shaped branching angle member 31 and supported and fixed by using any of the horizontal columns, the oblique support columns, and the trough bridge.

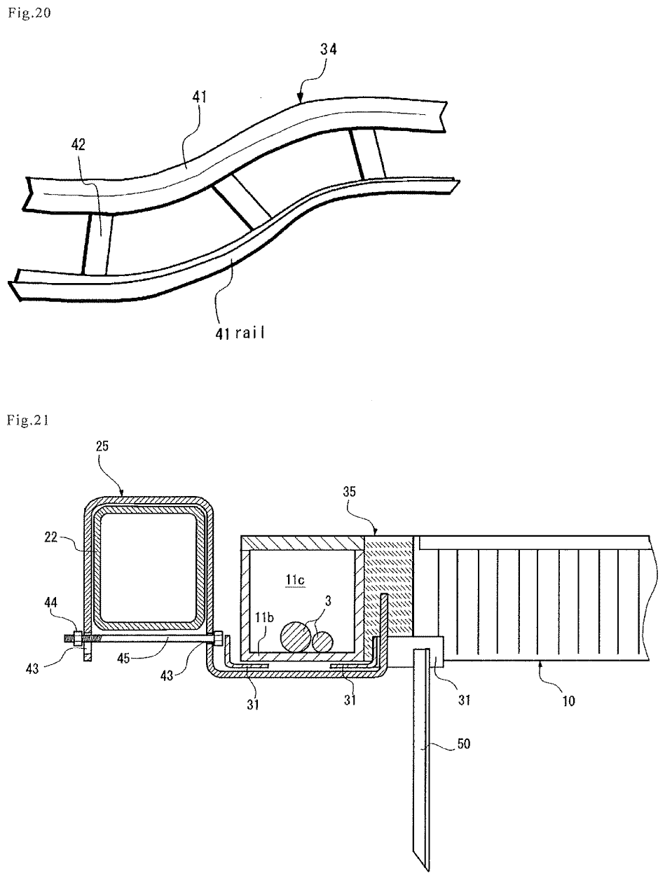

As shown in FIG. 19, the trough bridge pier 50 has an H-shaped structure or a two-tiered ladder-shaped structure, in which at least two mutually facing parallel vertical support columns 51 that also serve as support piles are connected by one or two horizontal support columns 52 and 53 that are predetermined distance, which is substantially equivalent to the trough width, away from one another.

Furthermore, the horizontal support columns 52 and 53 of the trough bridge pier 50 is configured in one or two tiers, and the vertical support columns 51 and the horizontal support columns 52 and 53 are fixed by welding or bolt fixing. Here, the support column of the second tier may not necessarily be fixed and may be formed as rotatable. When the horizontal support column 52 is in a one tier, the trough 10 is directly placed on the horizontal support column 52, and when the horizontal support columns 52 and 53 are in two tiers, the trough 10 is placed on the horizontal support column 53 of the upper tier.

Also, although it is preferable to have the two vertical support columns 51, a different trough bridge pier structure in which a substantially U-shaped support structure is formed on one vertical support column may also be used. Here, it is preferable that the vertical support column 51 has a thin and pointed tip end so as to be easily inserted into the ground. Furthermore, it is preferable that the vertical support column 51 used has an L-shaped cross section as shown in the drawing or a rectangular cross section.

### (Example of Bending Structure)

Below, a direction changing structure in which a direction changing member such as a bending angle member, an S-shaped bending angle member, or an inverted S-shaped bending angle member includes a bending structure will be specifically described.

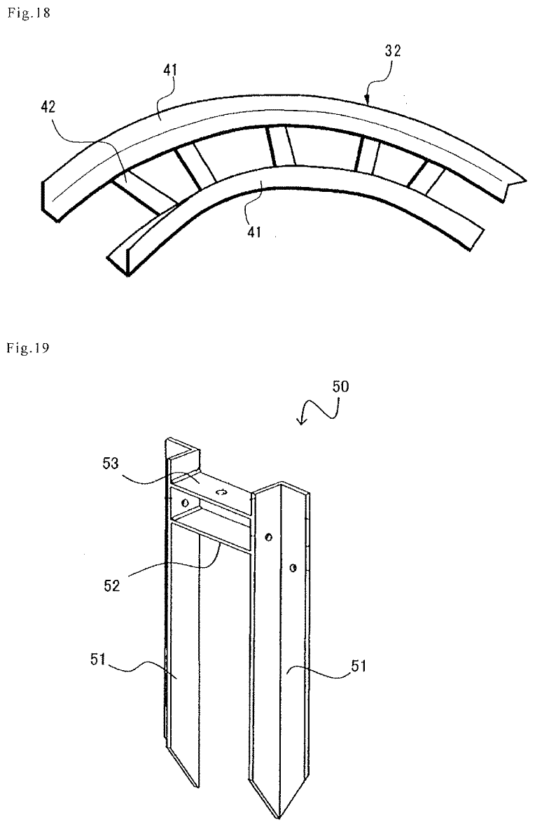

FIG. 18 is a perspective view schematically showing a C-shaped bending angle member 32. By employing the angle member 32 of the present embodiment, the angle member 32 can be applied when bending and disposing the electric wires and troughs. The angle member 32 includes two L-shaped rails 41 that are bent with a predetermined radius of curvature R, and auxiliary plates 42 that are disposed at key points for fixing the two rails. For such the member, either at least a part of the bending angle member and the side surface of the horizontal support column or the oblique support column are fixed to each other by bolting, or the bending angle member can be supported and fixed by a trough bridge or the like.

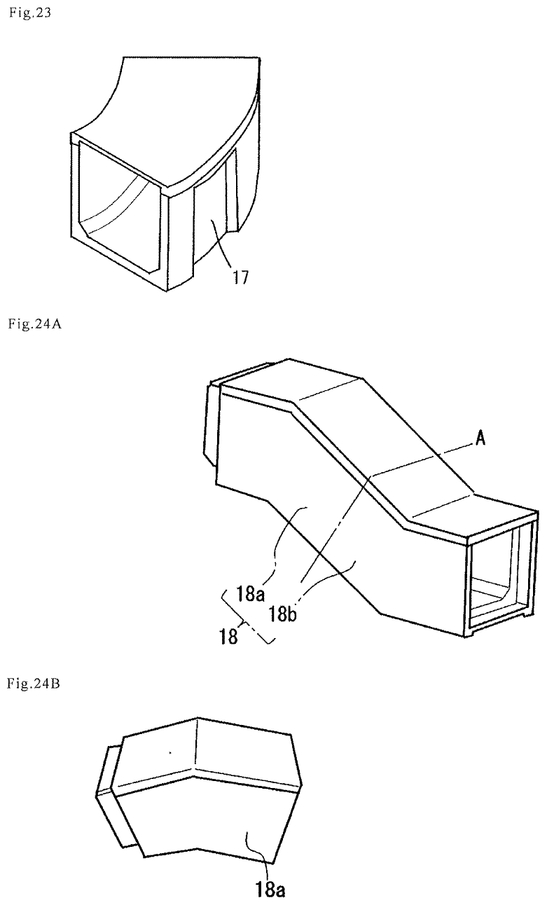

A bent trough 17 shown in FIG. 23 can be placed and fixed onto such the member. Although the bending angle member 32 with the bent trough 17 placed thereon being fixed to the horizontal support column, the oblique support column, or the trough bride is not specifically shown, the bent trough 17 having a radius of curvature that matches the radius of curvature of the bending angle member 32 can be used.

FIG. 20 is a perspective view schematically showing an S-shaped bending angle member 34. It is preferable that the above-mentioned direction changing structure includes the S-shaped bending angle member 34 or an inverted-S-shaped bending angle member (not shown). In this way, it is possible to guide the troughs more stably even in bent parts without causing excessive strain. By supporting such the member with the support member such as the trough bridge and further placing the bent trough on such the member to be connected and fixed thereto, which is then connected to an end of the trough before branching at a branching part, the direction changing structure using the direction changing member can be obtained. At this time, at least a part of the S-shaped bending angle member 34 and the side surface of the horizontal support column or the oblique support column can be fixed to each other using a bolt, or may be supported and fixed on the trough bridge.

Also, when fixing various types of troughs on the trough bridge, the angle member and the trough can be fixed to each other by attaching an L-shaped trough holding fitting.

The S-shaped bending angle member 34 and the inverted-S-shaped bending angle member both can provide the direction changing structure by inverting and connecting 45° bent troughs. For example, in a case of the S-shaped bending angle member 34, the center of curvature of the 45° bent trough is disposed to face toward the right side for an upper side and the center of curvature of the 45° bent trough is disposed to face toward the left side for a lower side, and in a case of the inverted-S-shaped bending angle member, the center of curvature of the 45° bent trough is disposed to face toward the left side for an upper side and the center of curvature of the 45° bent trough is disposed to face toward the right side for a lower side.

According to the present invention, a preferable method for supporting and fixing a trough structure can be provided. Specifically, a manufacturing method includes the following steps: a step in which hollow fiber-reinforced resin members having substantially rectangular cross sections are used as the horizontal support columns 22 or the oblique support columns 23 and the vertical support columns 21, and a plurality of the vertical support columns 21 are buried in the ground or supported and fixed with concrete at predetermined intervals.

Next, the method includes a step of assembling the support column structure 20 by bolt fixing the horizontal support columns 22 or oblique support columns 23 to one or both sides of the vertical support columns 21 in one or more tiers so as to be substantially perpendicular or oblique to the vertical support columns 21, and a step of further including the plurality of S-shaped trough fixing support members 25 in the support column structure 20.

More specifically, the S-shaped trough fixing support member 25 is configured with the inverted U-shaped first fixing portion 25a and the normal U-shaped second fixing portion 25b that are continuous to each other, and the method includes a step of hooking and fixing the inverted U-shaped first fixing portion 25a to the horizontal support column 22 or the oblique support column 23, and a step of placing the trough 10 on the normal U-shaped second fixing portion 25b. Through such the steps, the trough fixing support structure 100 in which the metal-made or resin-made trough structure 2 is supported can be obtained.

The supporting and fixing method according to one embodiment of the present invention further employs the following step. It is possible to provide a step of adjusting tightening level of the bolt 45 and the nut 44 that fix the inverted U-shaped first fixing portion 25a, which is mounted on the horizontal support column 22 or the oblique support column 23, via the screw hole 43 in the trough fixing support member 25.

This makes it easy to add, remove, or perform maintenance on the cables disposed in the metal-made or resin-made trough structure 2. Through such the steps, the trough structure 2 in which metal-made or resin-made troughs are connected can be supported by the trough fixing support structure 100 over a long distance in multiple tiers as necessary.

As described above, the present invention can provide a trough line that has various direction changing structures, including branching structures and direction changes of a trough fixing support structure in which a trough is placed and fixed using a trough fixing support member on a support structure that combines vertical support columns with either horizontal support columns or oblique support columns, as well as the trough fixing support structure combined with various angle members. In addition, it is also possible to provide a method for supporting and fixing a trough structure that supports troughs using horizontal, oblique, and vertical support columns.

Furthermore, the trough fixing support structure of the present invention uses a trough fixing support member including an inverted U-shaped first fixing portion and a normal U-shaped second fixing portion. On the other hand, the present invention also includes an invention of a trough fixing support member having the above structure. By using the trough fixing support structure of the present invention, the troughs can be laid in multiple tiers in the vertical direction of the support columns or on both sides of the support columns, so that even if the site is small, multiple troughs can be disposed in parallel, and further, there is an advantage that it is easy to maintain the cables disposed inside. In addition, by using various angle members as direction changing members in the trough fixing support structure, a direction changing structure from the trough fixing support structure can be provided.

1. A trough fixing support structure forming a support structure assembled by using hollow fiber-reinforced resin members having substantially rectangular cross sections as horizontal and/or oblique support columns and vertical support columns, and by fixing the horizontal support columns in one or more tiers with fixing bolts to one or both sides of the vertical support columns, which are buried in the ground or supported and fixed by concrete at predetermined intervals, with at least the horizontal support columns being substantially perpendicular to the vertical support columns, or the oblique support columns being oblique to the vertical support columns, wherein:
a plurality of S-shaped trough fixing support members can be arranged in the support column structure; and
each of the plurality of S-shaped trough fixing support members is configured such that an inverted U-shaped first fixing portion and a normal U-shaped second fixing portion are integrally connected to each other, and the plurality of trough fixing support members are fixed by hooking the inverted U-shaped first fixing portions onto any position of the horizontal support columns or the oblique support columns where the horizontal support columns or the oblique support columns do not interfere with the vertical support columns, and a plurality of troughs can be placed on the normal U-shaped second fixing portions of the plurality of trough fixing support members.

2. The trough fixing support structure according to claim 1, wherein:
at least either of the horizontal support columns or the oblique support columns are assembled in one or more tiers with fixing bolts;
the troughs that are arranged continuously form a trough structure, each of the troughs including a trough body having a substantially U-shaped cross section and a trough lid placed and fixed onto the trough body;
the trough structure is formed of either a male-female joint structure of the adjacent troughs or a close-arrangement of the troughs having only trough storages, without the male-female structure, and the matching trough lids;
the trough structure is disposed either on the horizontal support columns or the oblique support columns that are disposed on the one or both sides of the vertical support columns; and
the troughs of the trough structure are placed on the second fixing portions of the S-shaped trough fixing support members.

3. The trough fixing support structure according to claim 2, wherein when the inverted U-shaped first fixing portion is mounted on the horizontal support column or the oblique support column, two holes are provided in the first fixing portion of the S-shaped trough fixing support member at mutually opposing and symmetrical positions at parts extending below a position corresponding to a lower surface of a support column cross section of either the horizontal support column or the oblique support column so as not to obstruct an insertion of a bolt, and the bolt is inserted into the two holes and tightened with a nut to fix the trough fixing support member to the horizontal support column or the oblique support column.

4. The trough fixing support structure according to claim 3, wherein either a bottom portion of each of the troughs of the trough structure placed on the second fixing portion is simply placed on the second fixing portion, or bolt insertion holes are provided at predetermined positions on the second fixing portion and the bottom portion of each of the troughs of the trough structure placed on the second fixing portion and a bolt is inserted into the bolt insertion holes and fixed to the second fixing portion with a nut.

5. The trough fixing support structure according to claim 2, wherein when the trough structure is to be fixed to the horizontal support column or the oblique support column configuring the trough fixing support structure, one or two of the trough fixing support members are to be provided for each of the troughs of the trough structure.

6. The trough fixing support structure according to claim 2, wherein when the one trough fixing support member is disposed for each trough in the longitudinal direction of the troughs of the trough structure fixed to the horizontal support column configuring the trough fixing support structure, the trough fixing support member supports a position that is a predetermined distance away from a center of gravity of the trough toward the female joint structure.

7. The trough fixing support structure according to claim 2, wherein a flat-plate shaped or substantially C shaped long support base is disposed between the trough bottom portion of the trough structure placed on the second fixing portion of the trough fixing support member and the second fixing portion.

8. The trough fixing support structure according to claim 1, wherein the troughs placed on the trough fixing support members are metal-made troughs having the same cross-sectional shape in the longitudinal direction, and the metal-made troughs are fixed to the trough fixing support members in a state in which the metal-made troughs are abutted against each other and continuously arranged, or the metal-made troughs are fixed to the trough fixing support members in a state in which a gap is created between the metal-made troughs and the gap is covered with a cover member.

9. The trough fixing support structure according to claim 1, wherein instead of the hollow fiber-reinforced resin members having the substantially rectangular cross sections, the solid fiber-reinforced resin members having substantially rectangular cross sections are used for the horizontal and oblique support columns, and at least one of long sides of the horizontal and oblique support columns having substantially rectangular cross sections is abutted to the vertical support column to be fixed.

10. The trough fixing support structure according to claim 1, wherein:
the hollow or solid fiber-reinforced resin member having the substantially rectangular cross section is a fiber-reinforced resin composite material that is formed of at least one of thermoplastic resin and thermosetting resin with glass fiber formed of filamentous filament; and
the glass fiber is disposed on a surface of the fiber-reinforced resin member with the filamentous filament as a continuous body.

11. The trough fixing support structure according to claim 10, wherein:
the fiber-reinforced resin member of the trough fixing support structure is made of thermoplastic resin or thermosetting resin;
the thermoplastic resin is any one of polypropylene resin, ABS resin, PC resin, PBT resin, PPO resin, and PA resin, or the thermosetting resin is either urethane resin or epoxy resin; and
the glass fiber is disposed such that filament is wound around the surface of the fiber-reinforced resin member in parallel or at a predetermined angle to the longitudinal direction, or is intertwined and wound around the surface at a predetermined angle.

12. The trough fixing support structure according to claim 2, wherein:
the trough fixing support structure is a support structure in which the horizontal or oblique support columns are assembled in multiple tiers with fixing bolts; and
the horizontal or oblique support columns of another support structure are fixed to the other support structure being tilted at a predetermined angle in the horizontal or vertical direction relative to the horizontal or oblique support columns of the support structure so as to be connected to at least one end of the horizontal or oblique support columns of the multiple tiers in a different direction, such as obliquely downward or obliquely to the side, such that the trough fixing support structure includes a direction changing structure for directing a part of the troughs of the trough structure fixed to the horizontal or oblique support columns of the support structure in a direction different from an original arrangement direction of the troughs of the trough structure.

13. The trough fixing support structure according to claim 2, the trough fixing support structure further comprising a direction changing member that guides some of the troughs of the trough structure, which are supported and fixed by the trough fixing support members arranged on the support column structure, toward an arrangement direction of other troughs, which are supported and fixed by the trough fixing support members arranged on a support column structure other than the support column structure.

14. The trough fixing support structure according to claim 13, wherein:
the trough fixing support structure includes the direction changing structure;
the direction changing member is either an upward-downward gradient angle member or a T-shaped branching angle member;
the direction changing structure using the direction changing member includes a structure that guides the troughs in a different direction in the vertical direction while facing in the same direction as the original direction in a plan view before being connected to the direction changing member, or guides the troughs to branch off in a direction different from the original direction before being connected to the direction changing member.

15. The trough fixing support structure according to claim 13, wherein:
the trough fixing support structure includes the direction changing structure;
the direction changing member is a direction changing member including any of a bending angle member, an S-shaped bending angle member, and an inverted S-shaped bending angle member; and
the direction changing structure using the direction changing member includes a structure that guides the troughs in a curved direction in a plan view different from the original direction before being connected to the direction changing member by using any one of the above direction changing members.

16. A trough line comprising:
the direction changing structure according to claim 13; and
a trough fixing support structure.

17. A method for supporting and fixing a trough structure using a trough fixing support structure including a support structure, wherein:
the support structure is assembled by using hollow fiber reinforced resin members having a substantially rectangular cross sections as horizontal support columns, oblique support columns, and vertical support columns, and fixing the horizontal or oblique support columns to one or both sides of the vertical support columns, which are buried in the ground or supported and fixed with concrete at predetermined intervals in one or more tiers with fixing bolts so that the horizontal support columns or oblique support columns are substantially perpendicular or oblique to the vertical support columns;
the trough fixing support structure further comprises a plurality of S-shaped trough fixing support members; and
each of the plurality of trough fixing support members is configured such that an inverted U-shaped first fixing portion and a normal U-shaped second fixing portion are integrally connected to each other, and the inverted U-shaped first fixing portions are hooked and fixed onto the horizontal support columns or the oblique support columns, and a trough structure in which a plurality of troughs are continuously disposed is placed on the normal U-shaped second fixing portions of the plurality of trough fixing support members so that the trough structure is supported by the trough fixing support structure.

18. The method for supporting and fixing the trough structure according to claim 17, wherein the metal-made or resin-made trough structure, which is subjected for adding, removing, and maintaining cables disposed in the metal-made or resin-made trough structure, is supported by the trough fixing support structure by adjusting tightening level of a bolt and a nut that fix the inverted U-shaped first fixing portion, which is mounted on the horizontal support column or the oblique support column, of the trough fixing support member.

19. A trough fixing support member having an S shape, the trough fixing support member comprising:
an inverted-U-shaped first fixing portion;
a normal U-shaped second fixing portion, wherein:
the first fixing portion has two holes provided at mutually opposing and symmetrical positions at parts extending to a lower side below a horizontal support column or oblique support column when the inverted U-shaped first fixing portion is mounted on the horizontal support column or the oblique support column, such that a bolt can be inserted into the two holes and tightened with a nut; and
the second fixing portion, which is a U-shaped opening further beyond the first fixing portion, has a structure on which a metal-made or resin-made trough structure can be placed.

20. The trough fixing support member according to claim 19, wherein when the trough fixing support member used for a solid support column is attached to the horizontal support column or oblique support column having a solid structure with substantially rectangular cross section, since the support column is attached with a long side of the solid structure as an attaching surface, an inner surface width of the inverted U-shaped first fixing portion is substantially equivalent to a short side of the solid structure with the substantially rectangular cross section and a length of the U-shaped first fixing portion is formed into a size that bolt holes can be provided at parts extending to a lower side below the long side of the cross section of the horizontal support column or oblique support column.

21. A trough fixing support structure comprising:
a support column structure that stands on a fixed surface and is formed by combining a plurality of horizontal and/or oblique support columns that are made of fiber-reinforced resin members; and
a trough fixing support member that is detachably fixed to the horizontal and/or oblique support columns of the support column structure,
wherein resin-made troughs can be placed on the trough fixing support member.

22. The trough fixing support structure according to claim 21, wherein the trough fixing support member includes a hook shape that can be detachably fixed to horizontal and/or oblique support columns that are made of the fiber-reinforced resin member.
